(19) United States
(12) Patent Application Publication
(10) Pub. No.: US 2025/0007450 A1
(43) Pub. Date: Jan. 2, 2025

(54) ACCESSORY DEVICE FOR A SOLAR PANEL

(71) Applicant: JBB Advanced Technologies, LLC, DALLAS, TX (US)

(72) Inventors: John Brice Billingsley, JR., Dallas, TX (US); John Taylor Billingsely, Dallas, TX (US); Jason Alexander Novack, Frisco, TX (US)

(73) Assignee: JBB Advanced Technologies, LLC, DALLAS, TX (US)

(21) Appl. No.: 18/215,396

(22) Filed: Jun. 28, 2023

(51) Int. Cl. H02S 40/30; H02S 40/38; H04L 67/10

(52) U.S. Cl. CPC H02S 40/30; H02S 40/38; H04L 67/10

(57) ABSTRACT

An accessory device that can be utilized in conjunction with a solar panel is disclosed. The accessory device includes a voltage converter for converting a first direct current (DC) from the solar panel to a second DC, a capacitor bank and a controller for modulating and conditioning the second DC, a battery for storing the conditioned DC, and a networking module. The networking module includes a processor, multiple memory devices, a first and second network interface cards, and a connector for receiving an axillary accessory device to be operated in conjunction with the accessory device.

### PRIORITY CLAIM

The present patent application claims priority under 35 U.S.C. § 119(e)(1) to provisional application No. 63/357,417 filed on Jun. 30, 2022, the contents of which are incorporated herein by reference.

### TECHNICAL FIELD

The present invention relates to solar panels in general, and in particular to an accessory device for a solar panel.

### BACKGROUND

In the modern world, the needs for electrical power are ubiquitous. However, many electrical power generators, such as coal or fossil fuel power plants, generate not only electrical power but also pollutants that are environmentally harmful while exhausting earth resources. In an effort to avoid these drawbacks, electrical energy obtained from renewable energy sources is increasingly popular in a global scale. For example, electrical power can be generated by using photovoltaic solar panels to harvest renewable energy of the sun. Solar panels are particularly well-suited to stand-alone applications in isolated areas. The tremendous growth in the solar industry is helping to achieve a cleaner and more sustainable energy future.

Consequently, it would be desirable to provide an improved apparatus that can be utilized in conjunction with a solar panel.

### SUMMARY

The method and apparatus disclosed herein are related to solar panels that generate DC power to one or more accessory devices that are connected to each other via a network. The solar panels can be erected in a group to form a solar farm. Each of the solar panels of the solar farm can optionally fitted with one or more accessory devices. The accessory device can act as a controller for other accessory devices that are connected directly to the controller or are made accessible via a wired or wireless local-area network. The usage of the solar farm enables specialized processing tasks to be accomplished without impacting the local power grid, thus obviating the regulatory restrictions that plague conventional power-intensive computing methods for performing the same specialized processing tasks. If additional computational capacity is needed, additional solar farms, fitted out in accordance with the teachings of the present invention, may be erected and connected via the same or disparate networks to perform the computational tasks collectively or separately, respectively. The present invention is ideally suited to parallelize and/or distributed computation where electric power is non-existent, in short supply, or overly expensive.

According to one embodiment, a main accessory device for a solar panel includes a voltage converter, a capacitor bank and a controller, a battery, a networking module, and a connector. The voltage converter converts a first direct current (DC) from the solar panel to a second DC. The capacitor bank and controller modulate and condition the second DC from the voltage converter. The battery stores the modulated and conditioned DC. The networking module includes a processor, some memory devices, a first network interface card to allow a user to control the main accessory device, and a second network interface card to allow communications among other main accessory devices. The connector is adapted to receive an ancillary accessory device to be operated in conjunction with the main accessory device.

All features and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1A illustrates a front side of a solar panel, according to one embodiment;

FIG. 1B illustrates a back side of the solar panel from FIG. 1A having a main accessory device, according to one embodiment;

FIG. 1C illustrates a back side of the solar panel from FIG. 1A having multiple accessory devices connected in series, according to one embodiment;

FIG. 2 is a block diagram of the main accessory device from FIG. 1B, according to one embodiment;

FIG. 3 is a detailed block diagram of a processing module within the main accessory device from FIG. 2, according to one embodiment;

FIG. 4 is a block diagram of an optional ancillary accessory device that can be coupled to the main accessory device from FIG. 2, according to one embodiment; and

FIG. 5 is a high-level flow diagram of a method for forming a mesh network using multiple main accessory devices from FIG. 2.

### DETAILED DESCRIPTION OF A PREFERRED EMBODIMENT

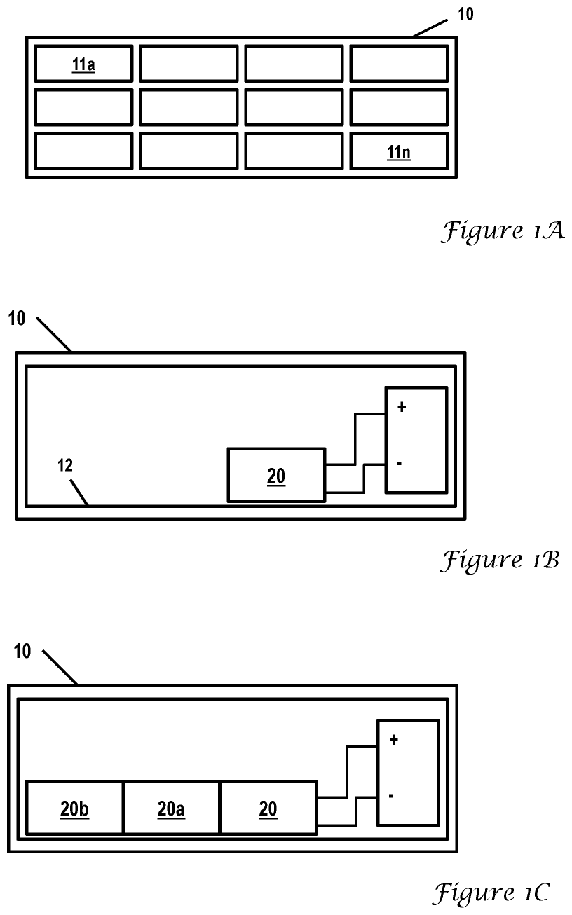

Referring now to the drawings and in particular to FIG. 1A, there is illustrated a front side of a solar panel, according to one embodiment. As shown, a solar panel 10 includes multiple solar modules 11a-11n that are comprised of solar cells. Depending on the number of solar modules 11a-11n, solar panel 10 can provide electrical power output from a few kilowatts to hundreds kilowatts in the form of direct current (DC).

Two types of accessory devices can be mounted on the back side of solar panel 10, namely, a main accessory device and optional ancillary accessory devices. For the present embodiment, each solar panel 10 should be equipped with one main accessory device. The primary function of a main accessory device is to communicate with other main accessory devices located on respective solar panels in order to form a distributed computing network.

With reference now to FIG. 1B, there is illustrated a back side of solar panel 10 having a main accessory device, according to one embodiment. As shown, a main accessory device 20 can be mounted on an edge flange 12 of solar panel 10 without interfering with the power generation operation of solar panel 10. Main accessory device 20 receives DC from a positive terminal and a negative terminal of solar panel 10.

Main accessory device 20 is encased in a chassis made of a type of material that enables main accessory device 20 to operate outdoors in a wide variety of weather conditions. In addition, the chassis is equipped with attachment clips that allow main accessory device 20 to be mounted to the back side of solar panel 10 such that solar panel 10 and main accessory device 20 can be moved as a single entity.

One or more optional ancillary accessory devices can be connected to main accessory device 20 on solar panel 10 to provide additional functionalities. There are different types of ancillary accessory devices, each for performing a specific function, as will be further described below herein.

Referring now to FIG. 1C, there is illustrated a back side of solar panel 10 having multiple ancillary accessory devices, according to one embodiment. As shown, ancillary accessory devices 20a-20b along with main accessory device 20 are mounted on edge flange 12 of solar panel 10 without interfering with the power generation operation of solar panel 10. Another way of referring to the accessory devices (particularly from a user's standpoint) is to designate main accessory device 20 as primary, second accessory device 20a as secondary, third accessory device 20b as tertiary, and so on. The number of accessory devices is limited only by the amount of power provided by solar panel 10 and any space constraints underneath solar panel 10. Main accessory device 20 and ancillary accessory devices 20a-20b are connected to each other in series physically and electrically. Main accessory device 20 receives DC power from a positive terminal and a negative terminal of solar panel 10. In turn, ancillary accessory device 20a receives DC power from main accessory device 20, and ancillary accessory device 20b receives DC power from ancillary accessory device 20a. Although only two ancillary accessory devices 20a-20b are shown in FIG. 1C, it is understood by those skilled in the art that the total number of ancillary accessory devices that can be mounted on the back side of solar panel 10 is only limited by the physical space and power requirements of ancillary accessory devices that can be supported by solar panel 10.

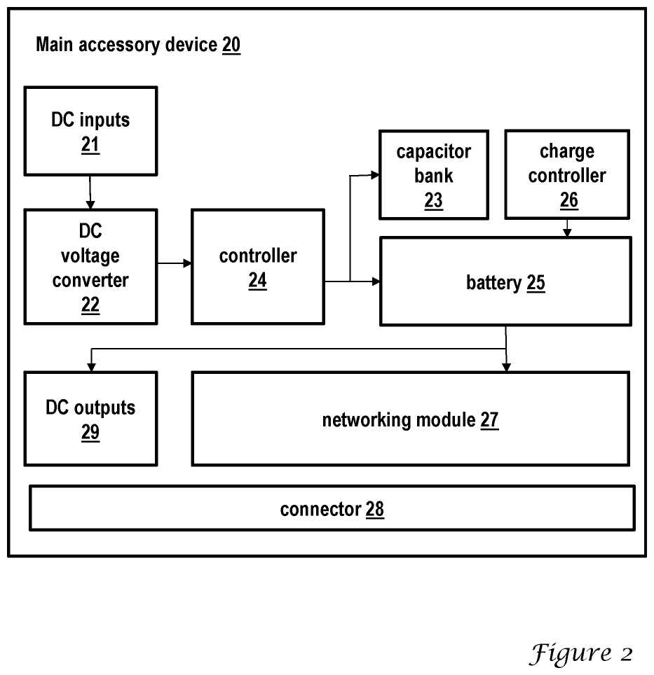

With reference now to FIG. 2, there is illustrated a block diagram of main accessory device 20, according to one embodiment. As shown, main accessory device 20 includes a pair of DC inputs 21 configured to be connected to the DC outputs of a solar panel, such as positive and negative terminals of solar panel 10 from FIG. 1, which can provide a DC output anywhere from 35 V to 65 V. The DC power from solar panel 10 is then fed through a DC conditioning section in order to smooth out the DC generated by solar panel 10. The DC conditioning section includes a DC voltage converter 22, a capacitor bank 23, a controller 24, and a battery 25. DC voltage converter 22 converts the DC outputs generated by solar panel 10 (i.e., anywhere from 35 V to 65 V) to ˜12 V or less, depending upon the requisite power consumption of the main accessory device 20. In conjunction with capacitor bank 23, controller 24 modulates and/or conditions the DC outputs from DC voltage converter 22. The DC outputs from DC voltage converter 22 are further smoothed out by battery 25. Battery 25 is protected by a charge controller 26 from any damages that can be caused by power surges. Once charged, battery 25 can also supply electrical power to other active components within auxiliary device 20 when the electrical power produced by the solar panel is reduced temporarily due to a passing cloud, hazy conditions, or the like.

Main accessory device 20 includes a networking module 27 for communicating with other main accessory devices located on respective solar panels to form a distributed computing network. Networking module 27 is powered by the ˜12 V DC from battery 25.

Main accessory device 20 also includes a connector 28 for receiving an optional ancillary accessory device, such as ancillary accessory device 20a from FIG. 1C. Connector 28 allows DC to travel from main accessory device 20 to power ancillary accessory device 20a. Connector 28 also allows data to travel between main accessory device 20 and ancillary accessory device 20a.

Any DC power generated by solar panel 10 that is not consumed by main accessory device 20 will be automatically directed to DC outputs 29. DC outputs 29 enable solar panel 10 to be connected to other solar panels in a new or existing solar panel farm. This functionality allows a scenario where main accessory device 20 to be added to new or upgraded solar panels and add new computing capability to an existing solar farm without impinging greatly on energy production of the solar farm, or in an alternate scenario, utilize the additional energy from the upgraded solar panel that would otherwise be wasted because of lack of inverter capacity for the solar farm. Moreover, the computational capability of main accessory device 20 and additional ancillary accessory devices can be utilized to form a distributed computing network on the solar farm. The distributed computing capacity afforded by the present invention can be utilized in a wide variety of manners, such as individuals within a small community, to stand-alone solar farms, up to and including commercial and distributed utility grid solar power plant.

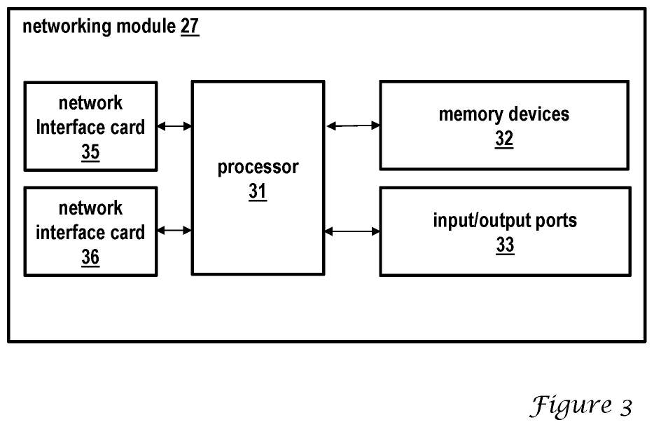

Referring now to FIG. 3, there is illustrated a detailed block diagram of networking module 27, according to one embodiment. As shown, networking module 27 includes a processor 31, one or more non-volatile and volatile memory devices 32, and one or more input/output (I/O) ports 33. Non-volatile storage devices may include read-only memories (ROMs) for storing operating systems and other firmware. Volatile storage devices may include random-access memories (RAMs) for data processing. I/O ports 33 may include general purpose input/output (GPIO) pins, external connectors for USB, PCIE, SATA connectors, etc.

Networking module 27 also includes a first network interface card 35 and a second network interface card 36. Both network interface cards 35, 36 can communicate with network devices external to networking module 27 wirelessly or via wires. With network interface card 35, networking module 27 can be wirelessly controlled by a computer, such as a desktop computer or a laptop computer. With network interface card 36, networking module 27 can wirelessly communicate with another networking module associated with a main accessory device located on a different solar panel.

Networking module 27 includes software instantiated to perform one or more tasks. For example, networking module 27 will handle communication signals from networking modules located on other solar panels to form a local-area network (LAN). In this way, a network mesh can be enabled using two or more networking modules so that signals can be conveyed from, for example, a first networking module located on a first solar panel to a second networking module located on a second solar panel. By using first network interface card 35, users are able to send and receive information to/from networking module 27, as well as to configure and or control any and all processes and tasks associated with networking module 27.

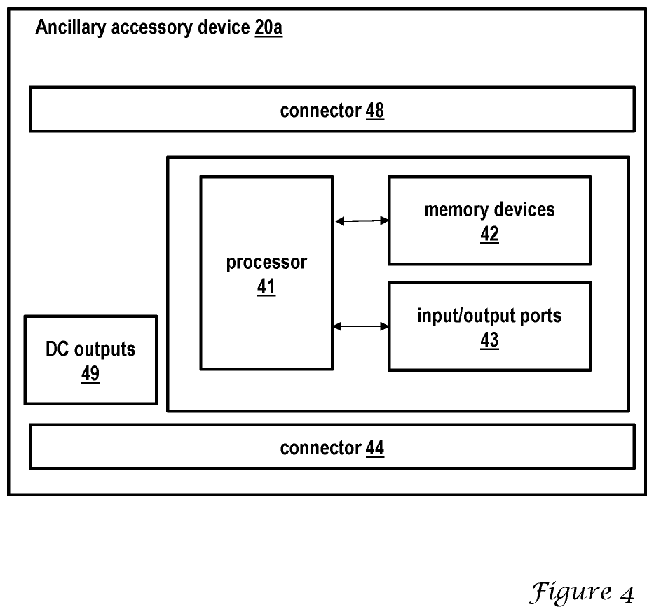

With reference now to FIG. 4, there is illustrated a block diagram of an optional ancillary accessory device, such as ancillary accessory device 20a (or 20b) from FIG. 1C, that can be connected to main accessory device 20, according to one embodiment. As shown, ancillary accessory device 20a includes a processor 41, multiple volatile and non-volatile storage devices 42, and I/O ports 43. Processor 41 is preferably a high-performance processor such as a graphical processing unit (GPU) to perform specific computational tasks. The type of processor employed will depend on the specific task to be performed by that ancillary accessory device. Non-volatile storage devices may include ROMs for storing firmware. Volatile storage devices may include RAMs for local data processing.

Ancillary accessory device 20a includes a connector 48 configured to receive connector 28 from main accessory device 20 (from FIG. 2). Connectors 48 and 28 allow DC power and data to travel between ancillary accessory device 20a and main accessory device 20. Ancillary accessory device 20a also includes a connector 44 configured to receive a connector from another ancillary accessory device.

Ancillary accessory device 20a includes software instantiated within ancillary accessory device 20a to perform one or more tasks. Ancillary accessory device 20a may include hardware and software that are pre-configured for a specialized task, such as machine learning, cryptocurrency mining, power storage (e.g., as a intelligent battery), data storage and other functions.

Similar to main accessory device 20, ancillary accessory device 20a is encased in a chassis made of a type of material that enables ancillary accessory device 20a to operate outdoors in a wide variety of weather conditions. In addition, the chassis is equipped with attachment clips that allow ancillary accessory device 20a to be mounted to the back side of solar panel 10 such that solar panel 10, main accessory device 20, and ancillary accessory device 20a can be moved as a single entity.

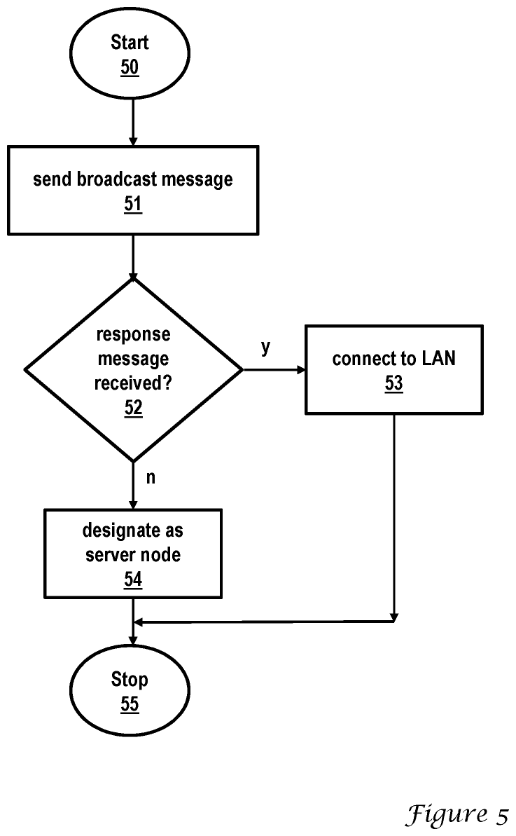

Referring now to FIG. 5, there is depicted a high-level flow diagram of a method for forming a mesh network using multiple main accessory devices 20 from FIG. 2. Staring at block 50, networking module 27 within main accessory device 20 detects whether or not there is a LAN (which is formed by a main accessory device similar to main accessory device 20) already exist within its proximity by sending a broadcast message via second network interface card 36, as shown in block 51.

Networking module 27 then determines whether or not a response message responsive to the broadcast message has been received, as depicted in block 52. If a response message has been received, networking module 27 can conclude that a LAN formed by another networking module similar to networking module 27 is already available, and second network interface card 36 can be configured to connect to the existing LAN, as shown in block 53, and the initiation process is completed, as shown in block 45. The LAN can identify all of the networking modules (similarly to networking modules 27) that are available on the LAN. During configuration, an IP address of second network interface card 36 can be configured based on the received response message.

However, if no response message has been received, networking module 27 can conclude that a LAN is not available, and second network interface card 36 can be configured as a server node of a new LAN, as depicted in block 54. For example, second network interface card 36 can be configured as a server node of the new LAN by initiating a client-server protocol, such as a Dynamic Host Configuration Protocol (DHCP).

After configuration, networking module 27 can set itself up to receive requests from other networking modules 27. Networking module 27 starts a router functionality so that networking module 27 can serve as a router to other networking modules 27, and can allocate, for example, internet protocol addresses, gateway, broadcast, DNS and any other information necessary for other networking modules 27 to function and communicate through the new LAN. It should be noted that this designation process can take place each morning when the sun rises to allow each solar panel to receive sunlight. In this way, a LAN is self-organizing where, depending upon the environmental conditions, any one of the accessory devices within a group of main accessory devices 20 may activate first and start the process of assembling a LAN and a distributed computing network. Once the first main accessory device 20 has been self-designated, networking module 27 within the first main accessory device 20 signals to the other accessory devices that it is available for performing computing tasks, and the initiation process ends, as shown in block 55.

After a LAN (mesh network) has been established, the LAN can be utilized to preform various tasks. For example, the LAN can be utilized to create a blockchain, with peer-to-peer communications take place among multiple networking modules 27, which act as nodes for the blockchain that perform the consensus mechanism, handle the encryption/decryption functions, and store the transactions/blocks that form the blockchain. The local blockchain can be used for local e-commerce, record and store local government information (such as deeds, birth records and the like), and other functions. Because the solar panels, such as solar panel 10 from FIG. 1, enable the blockchain to function during normal working hours, but do so without impart to the local power grid, the present invention can perform an invaluable service to a community. The blockchain can be a distributed ledger, à la Bitcoin, or a distributed computing machine, à la Ethereum, or other type of blockchain, such as a distributed autonomous organization or set of smart contracts that govern certain relations within the community.

As an example, a LAN formed by multiple networking modules 27 forms a decentralized computing system, whereas computation task that are paralelizable can be divided into individual subtasks that can be allocated to various primary module 27 that are known to exist on a LAN formed by multiple networking modules 27. A first networking modules 27 can act as a task aggregator and task allocator among the remaining networking modules 27 of the LAN. In short, a job request can be placed on the first networking module 27, and that job request would be communicated and transmitted by the first networking module 27 to the remaining primary modules 27 on the LAN. The first networking module 27 would then break the job request into subtasks and allocate those subtasks to be performed by the remaining networking modules 27 on the LAN, with the results being compiled by the first networking module 27 and, after the final result has been calculated, transmit that result to a networking module 27 that initiated the job request so it can transmit the result to a user. In this manner, the community provides the aggregate computing capacity to perform computations that would be impractical for one single networking module 27.

As has been described, the present invention provides an accessory device to be used in conjunction with a solar panel. Multiple accessory devices can be connected to form a distributed computing network.

While the invention has been particularly shown and described with reference to a preferred embodiment, it will be understood by those skilled in the art that various changes in form and detail may be made therein without departing from the spirit and scope of the invention.

What is claimed is:

1. A main accessory device for a solar panel, said main accessory device comprising:
a voltage converter for converting a first direct current (DC) from said solar panel to a second DC;
a capacitor bank and a controller for modulating and conditioning said second DC from said voltage converter;
a battery for storing said modulated and conditioned DC; and
a networking module having
a processor;
one or more memory devices coupled to said processor;
a first network interface card to allow a user to control said main accessory device; and
a second network interface card to allow communications among other main accessory devices; and
a connector for receiving an ancillary accessory device to be operated in conjunction with said main accessory device.

2. The main accessory device of claim 1, wherein said main accessory device includes a chassis equipped with attachment clips to allow said main accessory device to be mounted to a back side of a solar panel.

3. The main accessory device of claim 1, wherein the voltage of said first DC is higher than the voltage of said second DC.

4. The main accessory device of claim 1, further comprising a charge controller for protecting said battery from any damages due to power surges.

5. The main accessory device of claim 1, further comprising DC outputs for outputting any electrical power generated by said solar panel but not consumed by said main accessory device.

6. The main accessory device of claim 1, wherein said connector allows electrical power and data to be transmitted between said main accessory device and said ancillary accessory device.

7. The main accessory device of claim 1, wherein said ancillary accessory device includes a processor, one or more memory devices, and a plurality of I/O ports.

8. The main accessory device of claim 7, wherein said ancillary accessory device further includes DC outputs for outputting any electrical power generated by said solar panel but not consumed by said main and ancillary accessory devices.

9. The main accessory device of claim 8, wherein said ancillary accessory device further includes a connector for receiving another ancillary accessory device.

10. The main accessory device of claim 1, wherein a distributed computing system is formed by connecting a plurality of said main accessory devices wirelessly or via wire.

11. A method comprising:
providing a main accessory device to be used with a solar panel, wherein said main accessory device includes
a plurality of direct current (DC) conditioning devices for conditioning the DC from said solar panel, and
a networking module having a processor, one or more memory devices, a first network interface card, and a second network interface card;
sending a broadcast message from said second network interface card;
determining whether or not a response message is received responsive to said broadcast message;
in a determination that a response message is received responsive to said broadcast message, connecting said main accessory device to a network from which said response message was sent; and
in a determination that no response message is received responsive to said broadcast message, configuring said main accessory device as a server for a new network.
